(19) United States
(12) Patent Application Publication
(10) Pub. No.: US 2009/0183633 A1
(43) Pub. Date: Jul. 23, 2009

(54) FILTER COMB APPARATUS AND METHOD

(76) Inventors: Marc I. Schiller, Parsippany, NJ (US); Peter Gayer, Millburn, NJ (US)

Correspondence Address: Walter J. Tencza Jr.;Suite 210, 100 Menlo Park, Edison, NJ, 08837, US

(21) Appl. No.: 11/963,956

(22) Filed: Dec. 24, 2007

(51) Int. Cl. B01D 29/62; B01D 46/52

(52) U.S. Cl. 95/282; 55/289

(57) ABSTRACT

An apparatus comprising a filter comb, having a body portion is provided. The filter comb may be substantially ring shaped and may have a center which is hollow. The filter comb may have a plurality of inner projections each of which project towards the center of the filter comb. The plurality of inner projections may be spaced out substantially uniformly along an inner ring of the filter comb. The diameter of the filter comb may be approximately five and one half to ten inches. The filter comb may be made of plastic. There may be a gap between each of the plurality of inner projections and an adjacent inner projection and wherein the gap may be less than 0.075 inches.

### FIELD OF THE INVENTION

This invention relates to improved methods and apparatus concerning filters and more particularly pleated circular drum filters.

### BACKGROUND OF THE INVENTION

There are various devices known in the prior art for cleaning filters.

### SUMMARY OF THE INVENTION

One or more embodiments of the present invention provide an apparatus comprising a filter comb. The filter comb may have a body portion which is substantially ring shaped and has a center which is hollow. The filter comb may have a plurality of inner projections each of which project towards the center of the filter comb. The plurality of inner projections may be spaced out substantially uniformly along an inner ring of the filter comb. The filter comb may be adapted to fit onto a typical circular pleated drum filter. The typical circular pleated drum filter may have an outer diameter of approximately four to seven inches. The filter comb may have an outer diameter of between five and one half to ten inches. The filter comb may be made of plastic. There may be a gap between each of the plurality of inner projections and an adjacent inner projection and the gap may be approximately 0.075 inches or less than 0.075 inches.

The apparatus may include a filter having a plurality of pleated sections. The filter comb may be configured so that each of the plurality of inner projections are adapted to simultaneously fit into a corresponding one of the plurality of pleated sections. The filter may be a pleated drum filter. The filter comb may be configured so that it can be slid up and down the filter with the filter comb substantially perpendicular to the direction of motion and while each of the plurality of inner projections are fit into a corresponding one of the plurality of pleated sections.

In one embodiment, the apparatus may include a plurality of rods. Each of the plurality of rods may be situated so that the filter comb slides up and down the rods while the plurality of inner projections of the filter comb are inserted in a plurality of corresponding pleated sections of the filter. The apparatus may include a plurality of springs, one for each of the plurality of rods, each of the plurality of springs surrounding a portion of its corresponding rod of the plurality of rods. The filter comb may be configured so that it compresses the plurality of springs when the filter comb is moved in one direction and expands the plurality of springs when the filter comb is moved in the opposite direction.

The present invention also includes a method comprising using a filter comb to clean a filter, wherein the filter comb can be configured as previously described.

### BRIEF DESCRIPTION OF THE DRAWINGS

FIG. 1 shows a top view of a prior art filter for use with an embodiment of the present invention;

FIG. 2 shows a top view of a filter comb in accordance with an embodiment of the present invention placed over the filter of FIG. 1;

FIG. 3 shows a top view of the filter comb used in FIG. 2;

FIG. 4 shows a front and top perspective view of the filter of FIG. 1;

FIG. 5 shows a front and top perspective view of the filter of FIG. 1 with the comb of FIG. 3 placed over the filter;

FIG. 6 shows a front and top perspective view of the filter of FIG. 1 along with another apparatus in accordance with another embodiment of the present invention;

FIG. 7 shows a front and top perspective view of the filter of FIG. 1 along with another apparatus in accordance with another embodiment of the present invention; wherein springs are used;

FIG. 8A shows a top view of a filter comb in accordance with another embodiment of the present invention; and

FIG. 8B shows a front view of the filter comb of FIG. 8A.

### DETAILED DESCRIPTION OF THE DRAWINGS

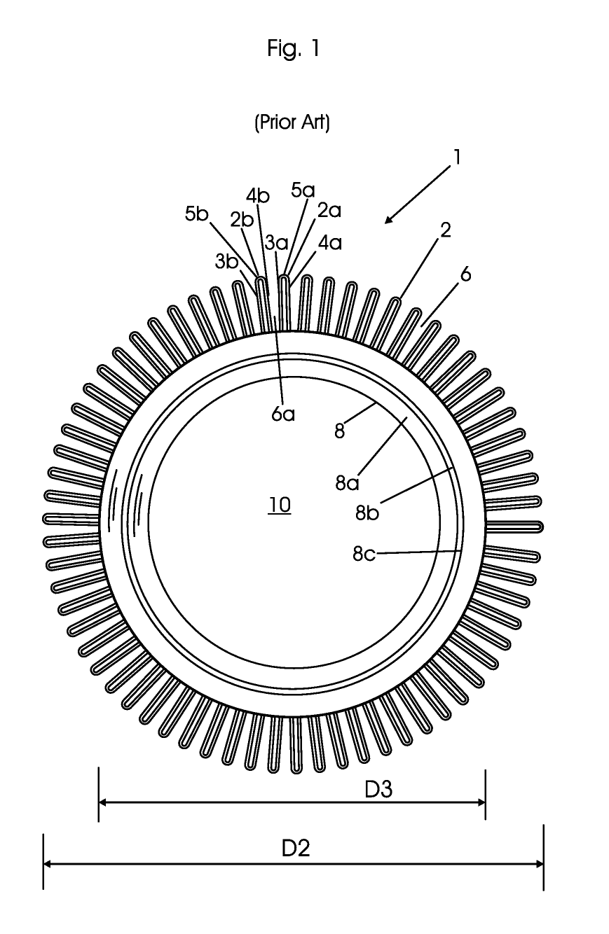

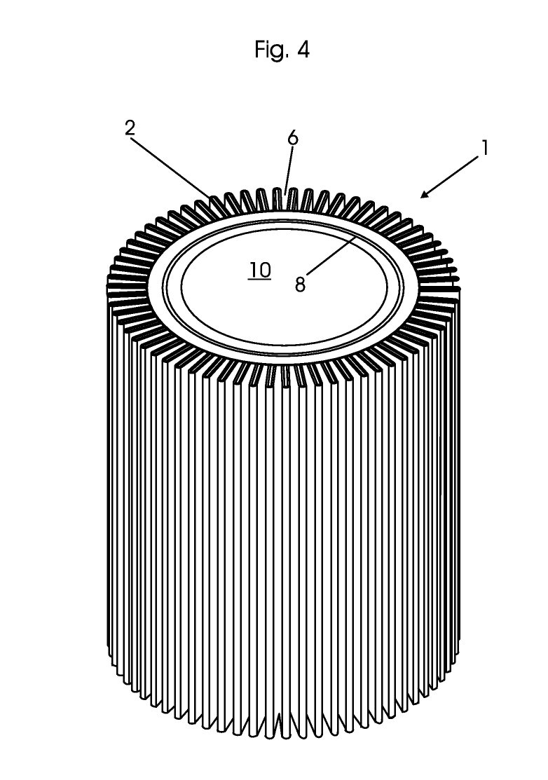

FIG. 1 shows a top view of a prior art pleated circular drum filter 1 for use with an embodiment of the present invention. FIG. 4 shows a front and top perspective view of the filter of FIG. 1. The filter 1 includes a plurality of filter sections, folds, or pleated sections 2, including filter sections or fold 2a and 2b. The filter fold 2a includes a tip section 5a, a left section 3a, and a right section 4a. The left section 3a and the right section 4a are connected to a circular core 8. The filter fold 2b includes a tip section 5b, a left section 3b, and a right section 4b. The left section 3b and the right section 4b are connected to the circular core 8. There are a plurality of gaps 6 between the filter sections or fold 2, such as gap 6a between filter folds 2a and 2b.

The circular core 8 includes sections 8a, 8b, and 8c. The circular core may be made of rubber or other elastomeric gasketing material. The filter 1 has a central opening 10.

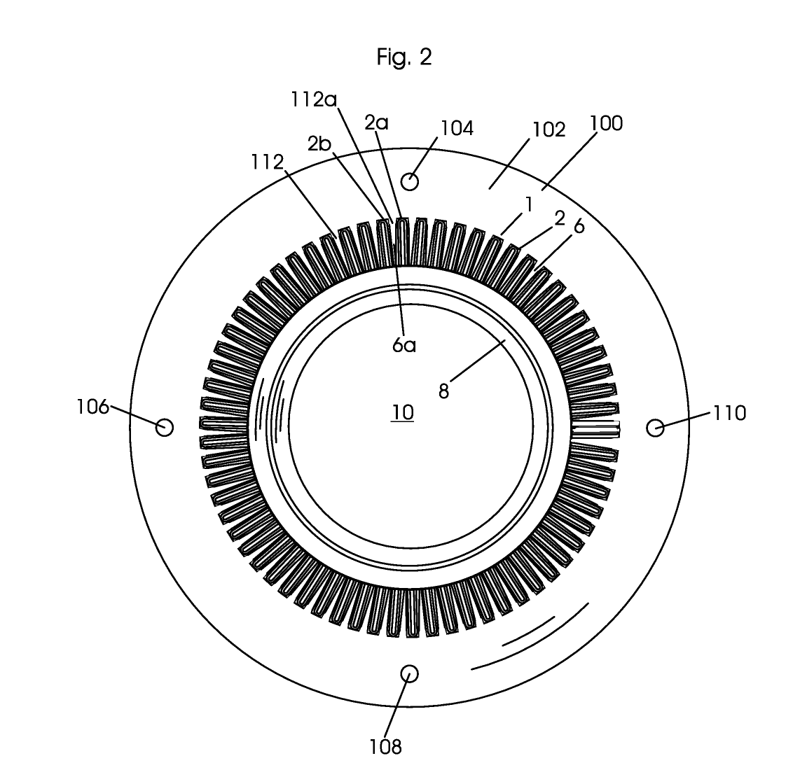

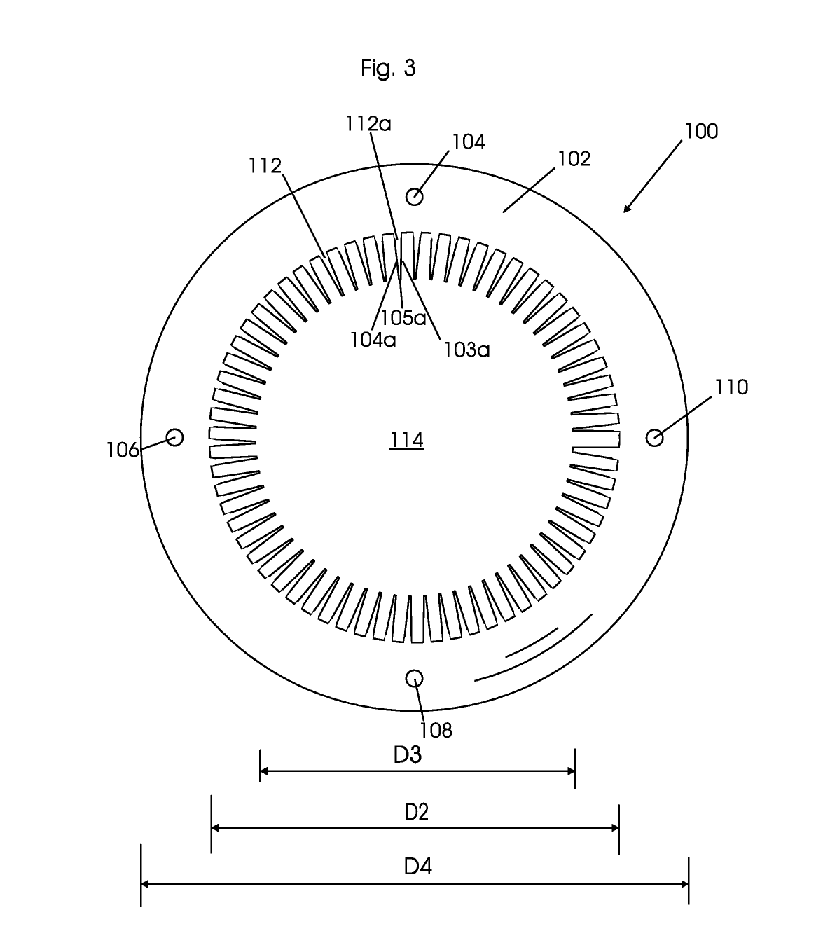

FIG. 2 shows a top view of a filter comb 100 in accordance with an embodiment of the present invention placed over the filter 1 of FIG. 1. FIG. 3 shows a top view of the filter comb 100 used in FIG. 2. The filter comb 100 includes a body or peripheral section 102, which may be made of plastic such as polypropylene, polystyrene, polyethylene or stamped or cast metal. The body section 102 has openings 104, 106, 108, and 110. The filter comb further includes a plurality of projections or protrusions 112, such as projection or protrusion 112a. There is one projection, of projections 112, for each gap of the plurality of gaps 6. For example, in the orientation shown in FIG. 2, projection 112a fits snugly within the gap 6a between the filter folds 2a and 2b. As shown in FIG. 3, the filter comb 100 may have a central opening 114. Each of the projections of projections 112 may have a left surface or section 104a, a tip section 105a, and a right section 103a.

The filter 1 shown in FIG. 1 may have an outer diameter of D2, which may be between six and seven inches, which is the distance from a tip of one fold or pleat to an opposing fold or pleat. The filter 1 may have a ring having a diameter of about D3 which may be five inches. The filter comb 100, shown in FIG. 3, may have an outer diameter of D4, which may be about ten inches, and a ring diameter of D2 which may be between six and seven inches and may correspond to the D2 of the filter 1 of FIG. 1. The filter comb 100 may also have an inner most diameter of D3, which may be the distance between an inner tip of a projection and an inner tip of its opposing projection.

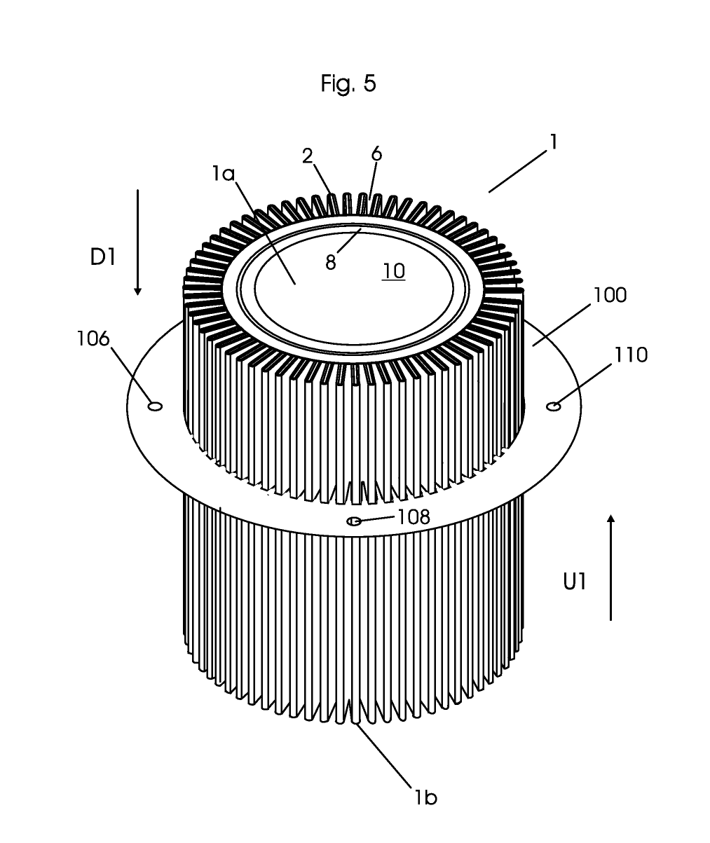

FIG. 5 shows a front and top perspective view of the filter 1 of FIG. 1 with the filter comb 100 of FIG. 3 placed over the filter 1. Referring to FIGS. 1-5, in operation, the filter comb 100 is placed over the filter 1 and pushed onto the filter 1 so that each one of the plurality of gaps 6 of the filter 1, has one projection of the plurality of projections 112 inserted into it as shown by FIGS. 2 and 5. The filter comb 100 is then pressed downward in the direction D1 shown in FIG. 5. As the filter comb 100 is pressed downwards in the direction D1, the projections 112, and the surfaces or sections of the projections 112, such as the sections 104a and 103a of the projection 112a and sections similar to those for the other projections of 112, push out any debris lying in the gaps 6 of the filter 1. The filter comb 100 is pushed from a top end 1a of the filter 1 to a bottom end 1b of the filter 1, in the direction D1. The filter comb 100 could alternatively be placed underneath the bottom end 1b of the filter 1, with the projections 112 aligned to fit within the gaps 6, and the filter comb 100 can then be pushed from the bottom end 1b to the top end 1a of the filter 1, in the direction U1.

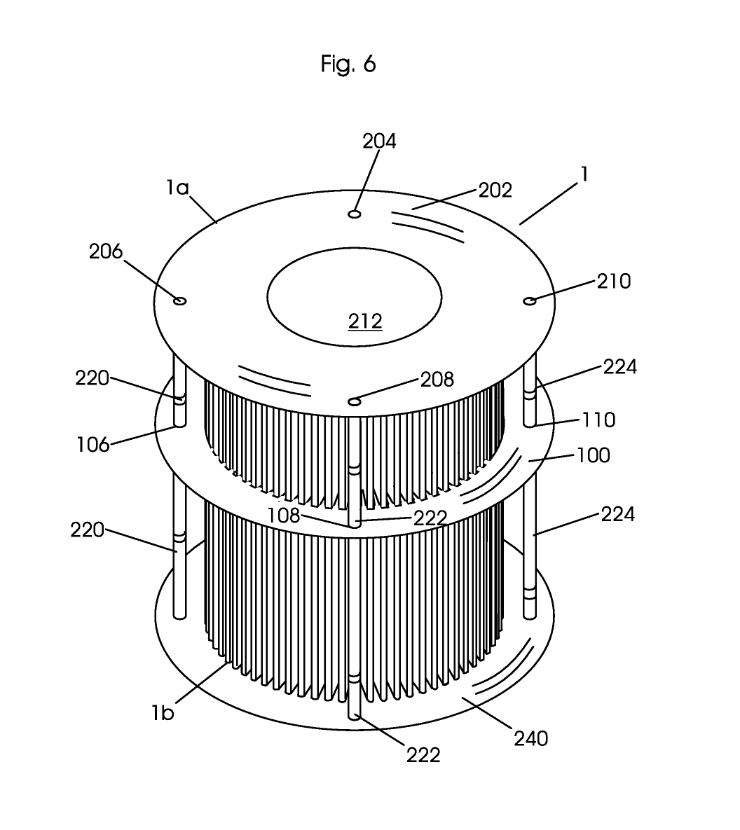

FIG. 6 shows a front and top perspective view of the filter 1 of FIG. 1 along with another apparatus in accordance with another embodiment of the present invention. FIG. 6 shows a top plate 202, the filter comb 100, and a bottom plate 240. The top plate 202 may be fixed to the top 1a of the filter 1. The bottom plate 240 may be fixed to the bottom 1b of the filter 1. Rods 220, 222, and 224, may each have one end fixed to the plate 202 and an opposite end fixed to the plate 240. There may also be a rod which is fixed at one end near opening 204 and which is fixed at an opposite end to bottom plate 240, similar to rod 222, but towards the back of filter 1.

In accordance with one embodiment of the present invention the rods 220, 222, 224, and the rod towards the back of filter 1, are inserted through openings 106, 108, 110, and 104 (shown in FIG. 3) of the filter comb 100, so that the filter comb 100 can slide up and down the rods 220, 222, and 224, and the rod towards the back of filter 1, while the filter comb 100 remains substantially perpendicular to its direction of motion. A motor can also be provided, not shown, for pushing the filter comb 100 up and down in order to clean the filter 1. The filter comb 100 may also be used without the top plate 202 and the bottom plate 240 and without the rods 220, 222, 224 and rod in back of the filter 1. The filter comb 100 would be manually manipulated vertically up in the direction U1 and down in the direction D1 to clean the pleated drum filter 1, with the filter comb 100 typically kept substantially perpendicular to the direction U1 or D1.

The filter 1 may be a vacuum filter such as a wet-dry filter. The projections 112 may be V-shaped or comb like, and may have a pointed or rounded section for section 105a shown in FIG. 3. The rods 220, 222, 224, and the rod towards the back of filter 1, may have spring action and/or long low force springs can be placed on the guide rods 220, 222, 224, and the rod towards the back of filter 1, to keep the filter comb 100 in place at the top and bottom of the filter 1. When the filter comb 100 is moved vertically up in the direction U1, or down in the direction D1, the long low force springs would move it in the opposite direction and return the filter comb 100 to its original position.

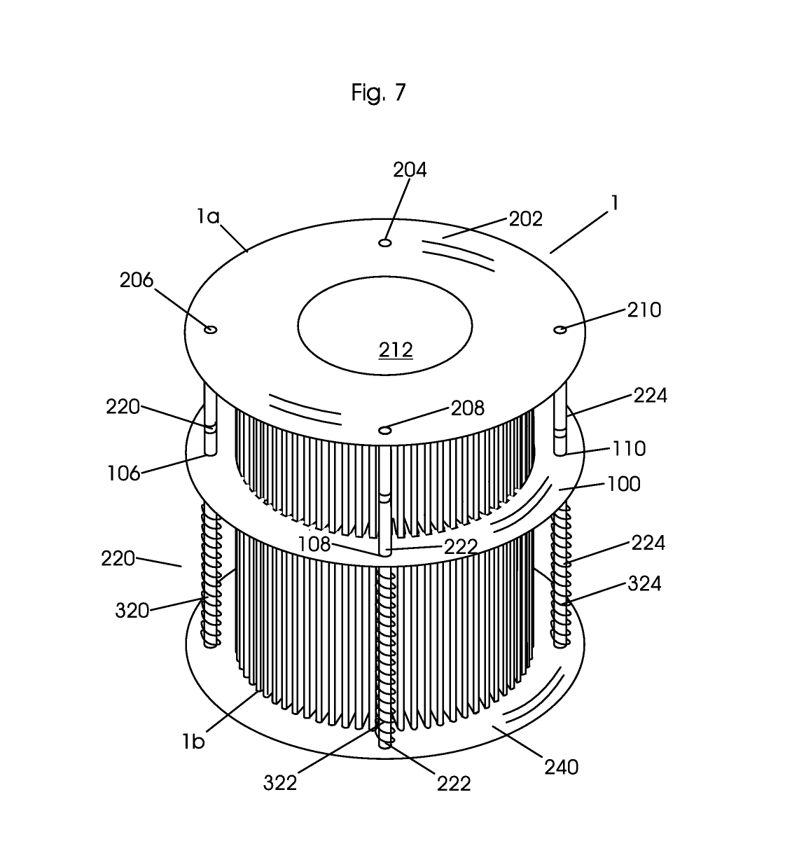

FIG. 7 shows a front and top perspective view of the filter 1 along with another apparatus in accordance with another embodiment of the present invention; wherein springs are used. FIG. 7 is the same as FIG. 6 except that springs 320, 322, and 324 have been added between the filter comb 100 and the bottom plate 240. There would also be a spring, not shown, corresponding to the rod towards the back of filter 1 opposite rod 222.

Referring to FIG. 7, in operation, when the filter comb 100 is pushed downwards towards the bottom plate 240, the springs 320, 322, and 324 become compressed. The filter comb 100 can be pushed forced downwards manually or by a motor or machine. After the filter comb 100 has substantially reached the bottom plate 240 or come as close as it can to the bottom plate 240, the force can be eliminated so that the filter comb 100 is allowed to return to an equilibrium position which may be near the top plate 202.

The number of projections 112 may be determined by the type of filter to be cleaned. Some filters have 100 folds, and for these filters 100 projections may be provided.

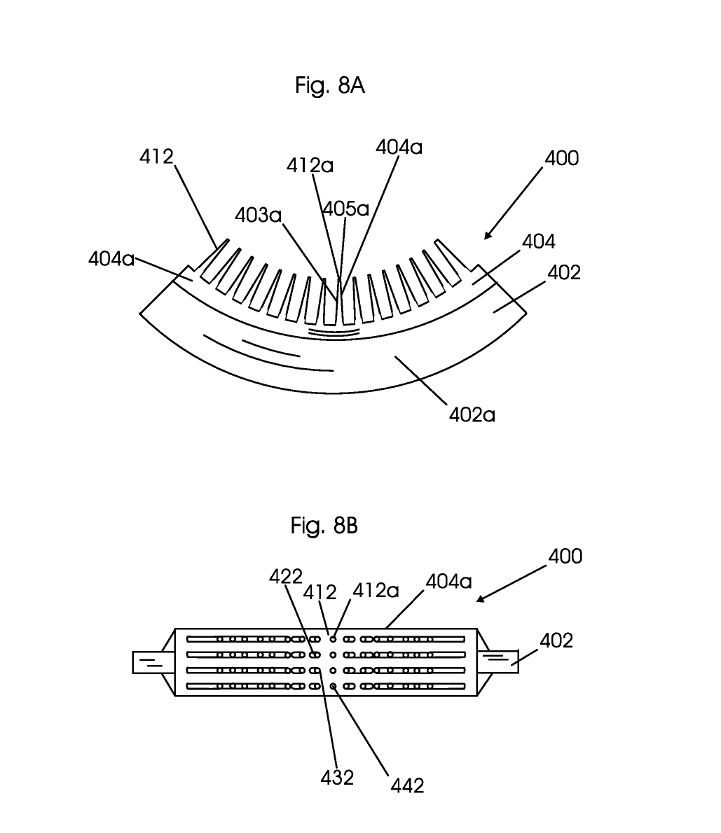

FIG. 8A shows a top view of a filter comb 400 in accordance with another embodiment of the present invention. FIG. 8B shows a front view of the filter comb 400 of FIG. 8A. The filter comb 400 may be a cutout of the filter comb 100, such as a quarter of the filter comb 100. Alternatively, the filter comb 400 may have several rows of projections or brush bristles and some other differences from the filter comb 100.

The filter comb 400 may include a body portion or handle portion 402 and a thicker section portion 404. The filter comb 400 may include four rows of bristles or projections, such as row 412, 422, 432, and 442, shown in FIG. 8B, connected to the thicker portion 404. The portion 404 may have a top surface 404a. Each projection of the projections of rows 412, 422, 432, and 442 may be substantially the same. As an example, the row 412 may include the bristle or projection 412a which may have a tip 405a, a left surface 403a and a right surface 405a. The other bristles or projections of rows 412, 422, 432, and 442 may be the same or similar to bristle 412a.

In operation the projections of rows 412, 422, 432, and 442 of the filter comb 400 can be inserted into a plurality of corresponding pleats or folds of the filter 1, and slid up and down the filter 1 in the direction U1 and D1, in order to clean the pleats or folds of the filter 1. One quarter of the filter folds of filter 1 can be cleaned and then the filter comb 400 can be placed in another quarter of the filter 1 folds or pleats and that quarter can then be cleaned. In this matter, the filter 1 can be cleaned quarter by quarter until the entire filter 1 is cleaned.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a filter comb;
wherein the filter comb has a body portion which is substantially ring shaped and has a center which is hollow;
and wherein the filter comb has a plurality of inner projections each of which project towards the center of the filter comb.

2. The apparatus of claim 1 wherein
the plurality of inner projections are spaced out substantially uniformly along an inner ring of the filter comb.

3. The apparatus of claim 1 wherein
The filter comb has an outer diameter and the outer diameter is in the range of five and one half to ten inches.

4. The apparatus of claim 1 wherein
the filter comb is made of plastic.

5. The apparatus of claim 2 wherein
there is a gap between each of the plurality of inner projections and an adjacent inner projection and wherein the gap is approximately equal to 0.075 inches.

6. The apparatus of claim 2 wherein
There is a gap between each of the plurality of inner projections and an adjacent inner projection and wherein the gap is less than 0.075 inches.

7. The apparatus of claim 1 further comprising
a filter having a plurality of pleated sections; and
wherein the filter comb is configured so that each of the plurality of inner projections are adapted to simultaneously fit into a corresponding one of the plurality of pleated sections.

8. The apparatus of claim 7 wherein
the filter is a pleated drum filter;
and wherein the filter comb is configured so that it can be slid up and down the filter with the filter comb substantially perpendicular to the direction of motion and while each of the plurality of inner projections are fit into a corresponding one of the plurality of pleated sections.

9. The apparatus of claim 1 further comprising
a plurality of rods;
wherein each of the plurality of rods are situated so that the filter comb slides up and down the rods while the plurality of inner projections of the filter comb are inserted in a plurality of corresponding pleated sections of a filter.

10. The apparatus of claim 9 further comprising
a plurality of springs, one for each of the plurality of rods, each of the plurality of springs surrounding a portion of its corresponding rod of the plurality of rods;
and wherein the filter comb is configured so that it compresses the plurality of springs when the filter comb is moved in one direction and expands the plurality of springs when the filter comb is moved in the opposite direction.

11. An apparatus comprising
a filter comb;
wherein the filter comb has a body portion which is substantially in the shape of a ninety degree arc;
and wherein the filter comb has a plurality of inner projections each of which project inward.

12. The apparatus of claim 11 wherein
the plurality of inner projections are formed into a plurality of rows of inner projections.

13. A method comprising:
using a filter comb to clean a filter;
wherein the filter comb is comprised of a body portion which is substantially ring shaped and has a center which is hollow;
and wherein the filter comb has a plurality of inner projections each of which project towards the center of the filter comb.

14. The method of claim 13 wherein
the plurality of inner projections are spaced out substantially uniformly along an inner ring of the filter comb.

15. The method of claim 13 wherein
the filter comb has an outer diameter and the outer diameter is between five and one half and ten inches.

16. The method of claim 13 wherein
the filter comb is made of plastic.

17. The method of claim 14 wherein
there is a gap between each of the plurality of inner projections and an adjacent inner projection and wherein the gap is approximately equal to 0.075 inches.

18. The method of claim 14 wherein
there is a gap between each of the plurality of inner projections and an adjacent inner projection and wherein the gap is less than 0.075 inches.

19. The method of claim 13 further comprising a filter having a plurality of pleated sections; and
wherein the filter comb is configured so that each of the plurality of inner projections are adapted to simultaneously fit into a corresponding one of the plurality of pleated sections.

20. The method of claim 19 wherein
the filter is a pleated drum filter;
further comprising sliding the filter comb up and down the filter with the filter comb substantially perpendicular to the direction of motion and while each of the plurality of inner projections are fit into a corresponding one of the plurality of pleated sections.

21. The method of claim 14 further comprising
sliding the filter comb up and down a plurality of rods while the plurality of inner projections of the filter comb are inserted in a plurality of corresponding pleated sections of a filter.

22. The method of claim 21 wherein
a plurality of springs are provided, one for each of the plurality of rods, each of the plurality of springs surrounding a portion of its corresponding rod of the plurality of rods;
and wherein the filter comb is configured so that it compresses the plurality of springs when the filter comb is moved in one direction and expands the plurality of springs when the filter comb is moved in the opposite direction.
